(19) United States
(12) Patent Application Publication
(10) Pub. No.: US 2018/0287932 A1
(43) Pub. Date: Oct. 4, 2018

(54) IDENTIFICATION OF AN SDN ACTION PATH BASED ON A MEASURED FLOW RATE

(71) Applicant: Hewlett-Packard Enterprise Development L.P., Houston, TX (US)

(72) Inventors: Claudio Enrique Viquez Calderon, Heredia (CR); Thomas A. Keaveny, Roseville, CA (US)

(21) Appl. No.: 15/764,566

(22) PCT Filed: Sep. 30, 2015
(86) PCT No.: PCT/US2015/053100

§ 371 Date: Mar. 29, 2018

(51) Int. Cl. H04L 12/721; H04L 12/717; H04L 12/729; H04L 12/741; H04L 12/851; H04L 12/715

(52) U.S. Cl. CPC H04L 45/38; H04L 45/42; H04L 45/64; H04L 45/745; H04L 47/2441; H04L 45/125

(57) ABSTRACT

Examples herein disclose a system including a meter and a networking component. The meter measures a flow rate associated with networking traffic. The networking component identifies a software defined networking (SDN) action path among multiple SDN action paths to perform on the networking traffic based on the measured flow rate.

### BACKGROUND

A software defined network (SDN) is an approach to networking that separates data and control functions of networking devices. As such, SDN decouples the network control and forwarding functions which enables the network to become programmable. OpenFlow is a communications protocol for implementing SDN.

### BRIEF DESCRIPTION OF THE DRAWINGS

In the accompanying drawings, like numerals refer to like components or blocks. The following detailed description references the drawings, wherein:

FIG. 1 is a block diagram of an example system including a networking device coupled to a first meter and a second meter to measure various flow rates of network traffic, the networking component identifies a first SDN action path and a second SDN action path based on the measured flow rates;

FIG. 2 is a block diagram of example meters including a first threshold and a second threshold to measure flow rates and identify an SDN action path;

FIG. 3 is a block diagram of example SDN action paths based on a measured flow rate from a meter;

FIG. 4 is a flowchart of an example method executable by a networking device to measure a flow rate of networking traffic and in response to the measured flow rate, identify an SDN action path;

FIG. 5 is a flowchart of an example method executable by a networking device to measure a flow rate of networking traffic and identifying an SDN action path;

FIG. 6 is a block diagram of an example computing device with a processing resource to execute instructions in a machine-readable storage medium for identifying an SDN action path based on a measured flow rate; and

FIG. 7 is a block diagram of an example computing device with a processing resource to execute instructions in a machine-readable storage medium for identifying various SDN action paths based on various measured flow rates.

### DETAILED DESCRIPTION

Openflow is a communications protocol that enables a networking device to determine a path of a networking packet through the SDN network. In OpenFlow, packet header information is retrieved from the packet and matched to information within a table to determine a SDN action based on this match. These actions are limited and may include dropping the packet, performing no action, and/or modifying a field within the packet. This set of SDN actions are limited in number which creates efficiency issues as more packets may be distributed amongst the limited number of SDN actions. For example, the fixed set of actions may increase in processing bandwidth as more packets may be distributed to the fixed set of actions. This slows down processing of the packets and decreases the efficiency of a networking system.

To address these issues, examples disclosed herein increases efficiency of a networking system by expanding the SDN actions performed on the networking packets. The examples provide a networking device which is coupled to a meter. The meter measures a flow rate of the networking traffic and based on the metered results, the networking device identifies an SDN action path among multiple SDN action paths specific to meter. The SDN action paths are each a series of SDN actions which may be performed on the networking packets. The identified SDN action path is the path of SDN action in which to route the networking traffic based on the measured flow rate. Distributing the networking packets to the series of SDN action increases the potential number of actions to process the networking packets, thus increasing the system efficiency. Additionally, by identifying a particular SDN action path based on the measured flow rate, provides load balancing to processing the networking packets.

In another example, the series of SDN actions within the identified SDN action path may include a more expansive set of SDN action than those listed through the OpenFlow protocol. For example, the SDN actions through OpenFlow may include dropping, modifying, or performing no action. The more expansive list may also include mirroring packet(s), rerouting the packet(s), routing the packet(s), forwarding packet(s) to a particular port or multiple ports, incrementing a counter associated with the packet(s), etc.

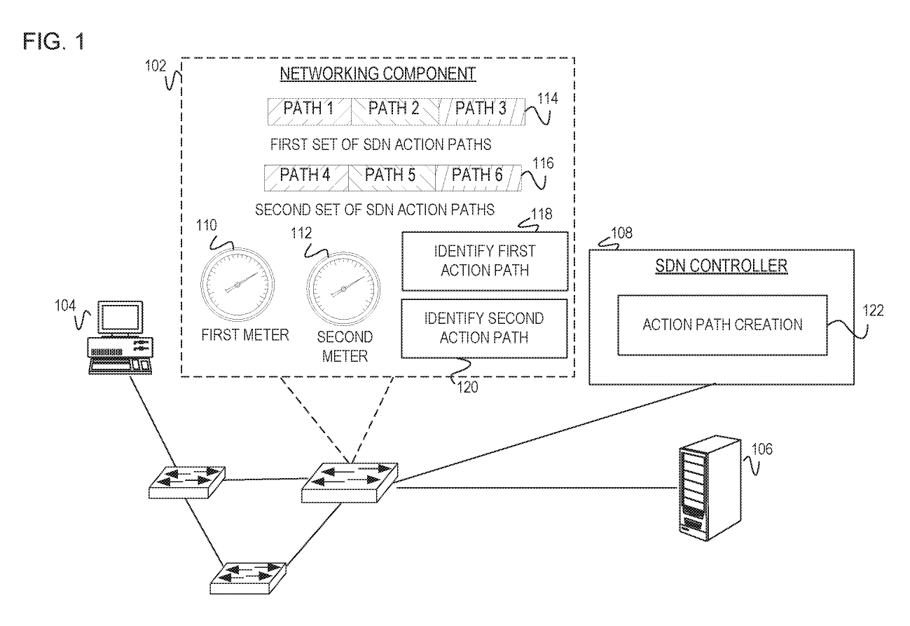

Referring now to the figures, FIG. 1 is a block diagram of an example system including a networking device 102 coupled to a first meter 110 and a second meter 112. The meters 110-112 measure various flow rates of networking traffic from a client 104 and/or other networking devices to an appropriate destination, such as a server 106. Measuring the various flow rates at meters 110-112, the networking device may identify a first SDN action path and a second SDN action path at modules 118-120. The first and the second SDN action paths may be identified from the corresponding sets of SDN action paths 114-116. These corresponding sets of SDN action paths 114-116 may be configured by an SDN controller 108. The system in FIG. 1 represents a networking system to receive and transmit networking traffic. As such, implementations of the system include a software defined network (SDN), domain name system (DNS) network, wide area network, legacy network, local area network (LAN), Ethernet, optic cable network, or other type of networking system capable of handling networking traffic. Although FIG. 1 illustrates the system as including components 102-108, implementations should not be limited as the system may include additional components such as an additional SDN controller, etc.

The networking device 102 is a component within the networking system of FIG. 1 that provides connections between the client 104, server 106, and/or other networking devices. The networking device 102 may process the networking traffic (e.g., data packet(s)) from the client 104 and other networking devices to determine which SDN action path in which to forward the networking traffic at modules 118-120. Implementations of the networking device 102 include, by way of example, a networking switch, router, virtual networking component, or other type of networking device 102 which routes networking traffic to the appropriate destinations. Although the networking device 102 includes the multiple meters 110-112 and sets of SDN actions 114-116, implementations should not be limited as the networking device 102 may further include a control plane and/or table to look up to decide where to route next SDN action path in which to route networking traffic.

The client 104 is a networking component that may exchange traffic with the networking server 106. Implementations of the client 104 include a router, server, mobile device, computing device, laptop, personal computer, laptop, networking switch, virtual networking component or other type of component capable of transmitting networking traffic. Although FIG. 1 illustrates a single client 104, implementations should not be limited as there may be multiple and/or types of clients.

The server 106 is a computing device which provides various network services, such as data storage, Internet connectivity, etc. The server 106 may be representative of the network destination for the networking traffic. Implementations of the server 106 include, by way of example, a Local Area Network (LAN) server, web server, cloud server, network server, file server, or other type of computing device capable of providing various network services within the networking system.

The first and the second meters 110-112 measure flow rates from networking traffic transmitted by the client 104. The flow rate may include an amount of networking traffic over a period of time and/or overall size of the networking traffic. Each meter 110-112 may include informal classifications of the flow rate, such as green, yellow, and red. The green classification is considered a lower value flow rate than yellow or red classification. The red classification is considered a higher value flow rate than the yellow classification and the green classification. In one implementation, the first meter 110 and the second meter 112 are each specific to a different criteria extracted in the packet header information. In this implementation, the criteria is a specific property used by the networking device 102 to filter the networking traffic to subsets of networking traffic. The subsets of networking traffic are routed to the corresponding meter 110-112 matching the criteria. The criteria may include, by way of example, an internet protocol (IP) address, media access control (MAC) address, a port number, a port interface, a particular virtual local area network (VLAN), protocols, etc. For example, the first meter 110 may include the subset of networking traffic matching a one IP address, while the second meter 112 may include the subset of networking traffic matching a different IP address. In this example, the first meter 110 measures the flow rate of the subset of networking traffic matching the IP address. Although the figures illustrates the meters 110-112 as each including three potential SDN action paths, implementations should not be limited as the meters 110-112 may each include a single SDN action path or more than three SDN action paths.

The sets of actions 114-116 are a series of SDN actions in which to perform on the networking traffic from the respective meter 110-112. Although through the OpenFlow protocol, the SDN actions may include dropping, forwarding, and/or modifying a field within the networking traffic, the sets of actions 114-116 may include a more expansive set of SDN actions. For example, each SDN action performed on the networking traffic may include mirroring packet(s), rerouting the packet(s), routing the packet(s), forwarding packet(s) to a particular port or multiple ports, incrementing a counter associated with the packet(s), etc. Each SDN action path listed in the sets of SDN action paths may include multiple occurrences of the single SDN action or combination of the SDN actions. As such, each is considered a path of series of SDN actions which may be performed on the networking traffic depending on the flow rate of the networking traffic at the meters 110-112. In one implementation, the first set of SDN action paths 114 specific to the first meter 110 are different from the second set of SDN action paths 116 specific to the second meter 112. In this implementation, the order in which to perform the SDN actions on the networking traffic may vary between each of the SDN action paths. For example, one SDN action path may first include mirroring a packet, then modifying the packet. Another SDN action path may first include routing the packet and then modifying a field within the packet. Each of these example SDN action paths are different.

At module 118-120, the networking device 102 identifies the first SDN action path and the second SDN action path in which to route the networking traffic that was measured by the first and the second meters 110-112. Each of the SDN action paths are identified based on the informal classification (e.g., green, yellow, red) of the flow rates measured at each respective meter 110-112. Using the classification, the networking device 102 identifies the corresponding SDN action path from the set of SDN action paths. In one implementation, the networking device 102 uses a first threshold and a second threshold to identify the SDN action path. This implementation may be discussed in detail in later figures. The modules 118-120 may include, by way of example, instructions (e.g., stored on a machine-readable medium) that, when executed (e.g., by the networking device 102), implement the functionality of modules 118-120. Alternatively, or in addition, the modules 118-120 may include electronic circuitry (i.e., hardware) that implements the functionality of modules 118-120.

The SDN controller 108 is a hardware component which communicates through OpenFlow to each networking device 102 to configure the set of SDN action paths 114-116 specific to each meter 110-112. In this manner, the SDN controller 108 configures the networking traffic flow rates and corresponding sets of SDN action paths 114-116 to each meter 110-112. Implementations of the SDN controller 108 may include a networking device, interface controller, processing device, or other type of networking controller.

At module 122, the SDN controller 108 configures the SDN action paths for each meter 110-112. In one implementation, the SDN action paths for the first meter 110 are different from the SDN action paths for the second meter 112. This means the series of SDN actions for each path are provided in a different order to be performed on the networking traffic. The module 122 may include, by way of example, instructions (e.g., stored on a machine-readable medium) that, when executed (e.g., by the SDN controller 108), implement the functionality of module 122. Alternatively, or in addition, the module 122 may include electronic circuitry (i.e., hardware) that implements the functionality of module 122.

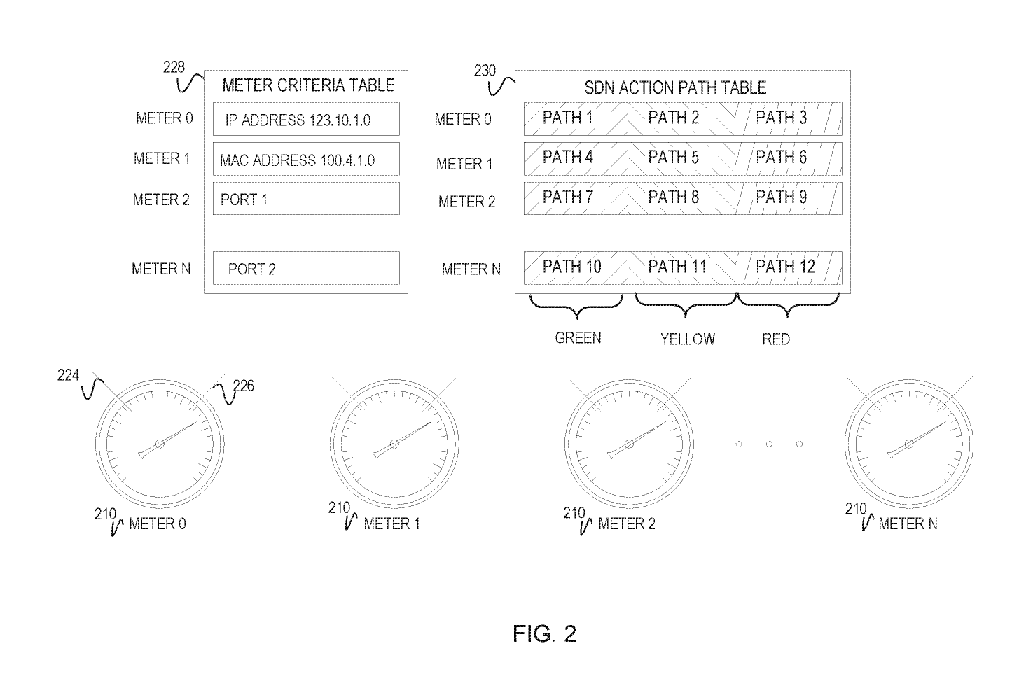

FIG. 2 is a block diagram of an example system including a meter criteria table 228 to identify which meter among multiple meters 210 to measure networking traffic. The multiple meters 210 (Meter 0-Meter N) each include a first threshold 224 and a second threshold 226 to measure a flow rate of the networking traffic. The meters 210 may include an informal classifications of green, yellow, and red to identify a corresponding SDN action path from an SDN action path table 230.

The criteria table 228 is used to match criteria within a packet header information from the networking traffic to the meter 210 (Meter 0-Meter N). The criteria is a property within the packet header that is matched to one of the multiple meters 210. The criteria may include an IP address, MAC address, port number, port interface, a particular virtual local area network (VLAN), protocols, etc. For example, Meter 0 includes the IP address 123.10.1.0. As such, the networking traffic with that listed IP address is filtered out and directed to Meter 0. In this manner, the filtered networking traffic is considered a subset of the networking traffic. Although the table 228 illustrates a different type of criteria (IP address, MAC address port number) corresponding to the meters 210, this was done for illustration purposes and was not intended for limitations. For example, the table 228 may include a same type of criteria, such as an IP address, but with a different IP addresses corresponding to each meter 210.

The first threshold 224 and the second threshold 226 are values on each meter 210 to identify where the measured flow rate lies on the metered flow rate. The thresholds 224 and 226 may be values as defined by an SDN controller through OpenFlow communication. These thresholds 224 and 226 may be redefined according to the SDN controller if the SDN controller desires to route more traffic on a specific path. The thresholds 224 and 226 are values as defined by the SDN controller to identify where the measured flow rate falls on the meter 210. Identifying whether the measured flow rate value falls above or below each of the thresholds 224 and 226 helps classify the measured flow rate. For example, if the measured flow rate falls below the first threshold 224 and the second threshold 226, this indicates a lower value and as such may be classified in green. If the measured flow rate falls above the first threshold 224 but below the second threshold 226, this indicates a higher value flow rate and as such may be classified in yellow. If the measured flow rate falls above the first threshold 224 and above the second threshold 226, this indicates a highest value flow rate and as such may be classified in red. Each of the classifications indicates as based on the meter 210 and measured flow rate, indicates which of the SDN action paths to take as in the table 230. Although FIG. 2 illustrates each of the meters 210 as including the same value of thresholds 224 and 226, this was done for illustrates purposes as the thresholds 224 and 226 may vary from meter to meter.

The SDN action path table 230 includes the various classifications (e.g., green, yellow, red) obtained based on the measured flow rates from the multiple meters 210. Based on the classifications from each of the meters 210 (Meter 0-Meter N), a networking device identifies the SDN action path (Path 1-Path 12) in which to route the networking traffic. Each meter 210 (Meter 0-Meter N) includes a set of SDN action paths that are specific to the meter. For example, Meter 0 includes Path 1-Path 3, Meter 2 includes Path 4-6, etc. This means the networking traffic which is measured by the given meter, is routed to one of the SDN action paths in the set of the SDN action paths. Each of the paths represents a series of SDN actions that may be performed on the networking traffic. These paths may include the same SDN action, but the order in which to perform the SDN actions varies. In another implementation, each path includes different SDN actions from other paths. A further example of the SDN action paths based on the measured flow rate may be described in detail in a later figure.

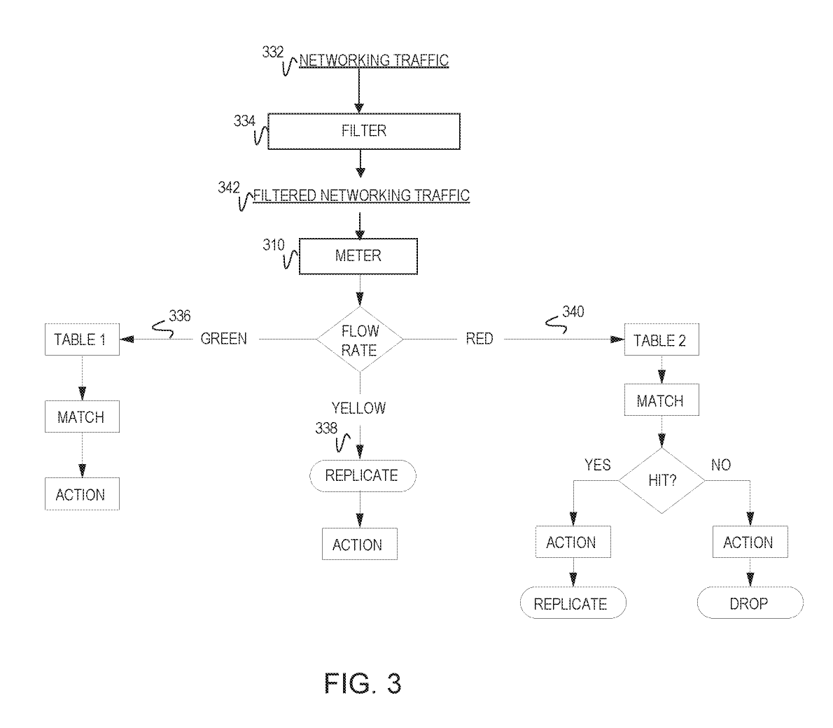

FIG. 3 is a flow diagram of example SDN action paths 336, 338, 340 based on a measured flow rate from a meter 310. Initially, the flow diagram includes networking traffic 332 which may be received by a filter 334. The networking traffic 332 may include at least one data packet which is received by the filter 334. The filter 334 extracts packet header information to determine which data packet(s) (i.e., networking packet(s)) match which meter 310. As such, the filter 334 may filter the networking traffic 332 to obtain the filtered networking traffic 342. The filtered networking traffic 342 is considered a subset of the networking traffic 332. The filtered networking traffic 342 includes those data packets which match the criteria in the extracted packet header. This filtered networking traffic 342 may be routed to the meter 310 based on the extracted packet header information. Upon the meter 310 receiving the filtered networking traffic 342, the meter 310 measures the flow rate corresponding to the filtered networking traffic 342. The flow rate may include the size of the overall filtered networking traffic 342 or the number of packets within the filtered networking traffic 342 over a period of time. Based on the flow rate as measured by the meter 310, a networking device may classify the flow rate as green, yellow, or red. From the classification, the networking device may route the filtered networking traffic 342 out to one of the various SDN action paths 336, 338, and 340. The various SDN action paths 336, 338, and 340 represent a series of ordered SDN actions in which the filtered networking traffic may be routed. Each of the SDN action paths 336, 338, and 340 represent the series of SDN actions the filtered networking traffic 342 may take based on where the flow rate falls on the meter.

The various SDN actions may include mirroring packet(s), rerouting the packet(s), routing the packet(s), forwarding packet(s) to a particular port or multiple ports, incrementing a counter associated with the packet(s), etc. The first SDN action path 336 corresponds to the green classification and includes such SDN actions as includes routing to a table, matching a packet, and performing another type of SDN action. The second SDN action path 338 corresponds to the yellow classification and includes such SDN actions as replicating and performing another type of SDN action. The third SDN action path 340 corresponds to the red classification and includes such SDN actions as routing to another table, matching, and a hit (e.g., whether a match is found). In an implementation, the order of the SDN actions may vary from path to path. In another implementation, the types of SDN actions may vary from path to path. Providing various SDN action paths provides flexibility in how to route the filtered networking traffic.

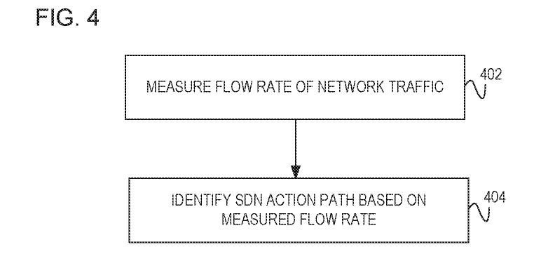

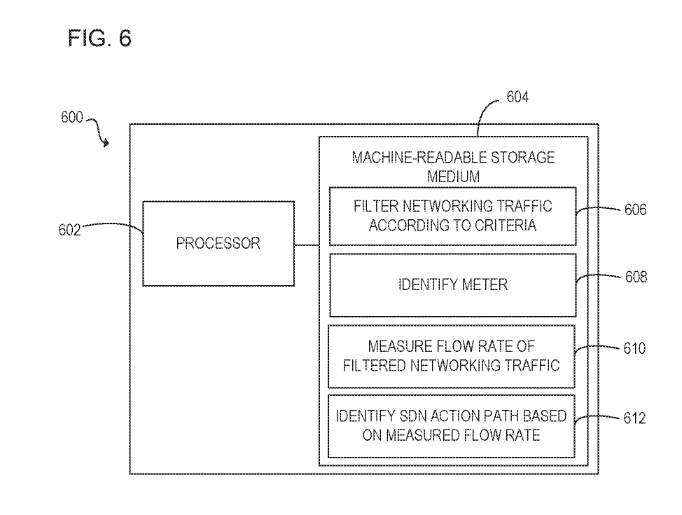

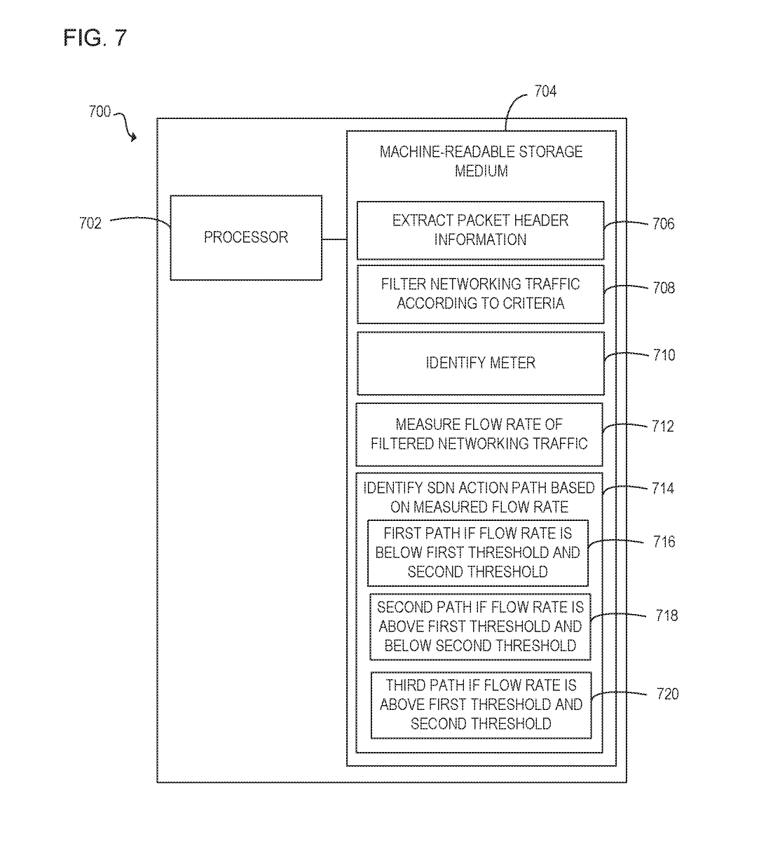

FIG. 4 illustrates a flowchart of an example method to identify an SDN action path based on a measured flow rate by a meter. The method is executable by a networking device to identify the SDN action path. The networking device may receive networking traffic and measures the flow rate at a meter. Upon measuring the flow rate of the networking traffic, the networking device identifies the SDN action path which corresponds to the measured flow rate. In discussing FIG. 4, references may be made to the components in FIGS. 1-3 to provide contextual examples. In one implementation, the networking device 102 executes operations 402-404 to identify which SDN action path to route the networking traffic. Although FIG. 4 is described as implemented by the networking device 102, it may be executable on other suitable components. For example, FIG. 4 may be implemented in the form of executable instructions on a machine-readable storage medium 604 and 704 as in FIGS. 6-7.

At operation 402, the networking device measures the flow rate of the networking traffic at the meter. The networking device may receive networking traffic which may be filtered according to a criteria the packet header(s). The criteria is a specific property that filters the networking traffic to a smaller amount of networking traffic that is directed to a particular meter. In this implementation, each meter is specific to a different criteria so the networking traffic that is matched to the criteria is routed to the respective meter. The criteria may include, by way of example, an internet protocol (IP) address, media access control (MAC) address, a port number, a port interface, a particular virtual local area network (VLAN), protocols, etc. The networking devices matches specific criteria within the packet header to identify those networking packets that should be directed to the meter. Upon directing the networking packets, the meter measures the flow rate of corresponding to the filtered networking traffic. The flow rate may include a number of packets received over a period of time and/or a size of the overall packets within the filtered networking traffic. As such, the meter may be organized according to different data rates. For example, the meter may be informally named with colors such as green, yellow, and red based on the different data rates. Green may include those data rates below a first threshold, yellow may include those data rates in between a first and a second threshold, and red includes those data rates higher than both data rates. This may be explained in detail in a later figure.

At operation 404, the networking device identifies which SDN action path to route the networking traffic based on the measured flow rate. The meter may include multiple SDN action paths specific to that meter. In this implementation, the SDN action paths associated with one meter is different than the SDN action paths associated with another meter. Providing various SDN action paths provides flexibility in how and where to route filtered networking traffic accordingly. Upon measuring the flow rate of the filtered networking traffic at operation 402, the networking device identifies which informal category (e.g., green, yellow, red) corresponds to the flow rate. Upon identifying the category, the networking device identifies the SDN action path specific to that category. Identifying the SDN action path, the networking device routes the filtered networking traffic to those series of SDN actions to execute on the filtered networking traffic.

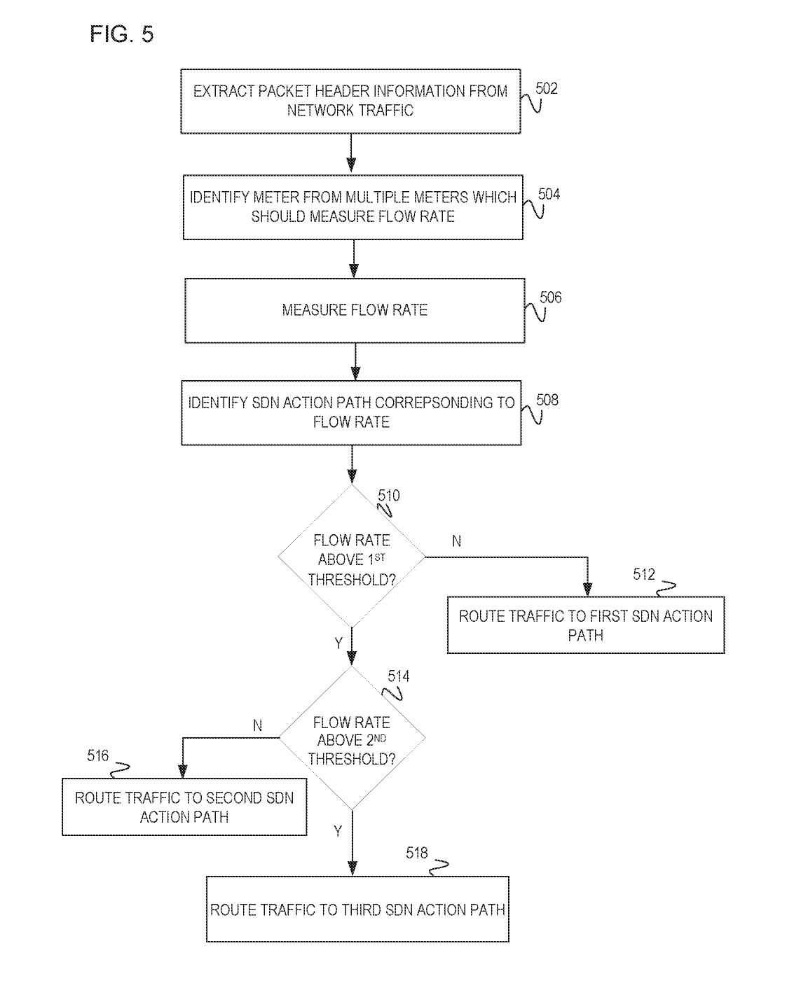

FIG. 5 illustrates a flowchart of an example method to measure a flow rate of networking traffic for identification of an SDN action path. The method is executable by a networking device to identify which SDN action path to perform on the networking traffic. The networking device extracts packet information from the networking traffic to group together those networking packets that match a criteria within the extracted packet header information. Grouping together the networking traffic based on the criteria specified within the packet header, the networking device identifies a meter specific to the criteria. The networking traffic is routed to the identified meter for measuring a flow rate. Upon measuring the flow rate at the meter, the networking device identifies which SDN action path corresponds to the measured flow rate. If the measured flow rate is below a first threshold, the networking device may route the networking traffic in accordance to a first SDN action path. If the measured flow rate is above the first threshold, the networking device proceeds to determine if the measured flow rate is above or below a second threshold. If the measured flow rate is below the second threshold (and above the first threshold), the networking device may route the networking traffic in accordance to the second SDN action path. If the measured flow rate is above the second threshold (and above the first threshold), the networking device may route the networking traffic in accordance to the third SDN action path. In discussing FIG. 5, references may be made to the components in FIGS. 1-3 to provide contextual examples. In one implementation, the networking device 102 executes operations 502-518 to identify which SDN action path to route the networking traffic. Although FIG. 5 is described as implemented by the networking device 102, it may be executable on other suitable components. For example, FIG. 5 may be implemented in the form of executable instructions on a machine-readable storage medium 604 and 704 as in FIGS. 6-7.

At operation 502, the networking device extracts packet header information from the networking traffic. The networking device may extract packet header information to classify each of the networking packets to the corresponding meter. In this manner, the extracted packet header information serves a criteria to match the networking packet to the corresponding meter. The criteria (e.g., packet header information) may include, by way of example, an internet protocol (IP) address, media access control (MAC) address, a port number, a port interface, a particular virtual local area network (VLAN), protocols, etc. The networking device matches the specific criteria within the packet header to identify those networking packets that should be directed to the corresponding meter.

At operation 504, the networking device identifies which meter from the multiple meters should measure the flow rate of the networking traffic. The networking device identifies which meter to route the filtered networking traffic based on the extracted packet header information. The networking device uses the extracted header information to match the networking packet to the corresponding meter.

At operation 506, the networking device measures the flow rate corresponding to the filtered networking traffic. Operation 506 may be similar in functionality to operation 402 as in FIG. 4.

At operation 508, the networking device identifies the SDN action path corresponding the measured flow rate. In one implementation, the networking device compares the measured flow rate against the first threshold and the second threshold as at operations 510-518. Measuring the flow rate against the thresholds, the networking device identifies which SDN action path should be performed on the network traffic. Operation 508 may be similar in functionality to operation 404 as in FIG. 4.

At operation 510, the networking device determines if the measured flow rate is above or below the first threshold. If the networking device determines the measured flow rate is below the first threshold, the networking device proceeds to operation 512. If the measured flow rates is above the first threshold, the networking device proceeds to operation 514 to determine whether the measured flow rate falls above or below the second threshold.

At operation 512, if the measured flow rate falls below the first threshold, this means the measured flow rate is a lower value. As such, the flow rate may be organized into the green classification. The networking device may proceed to route the filtered networking traffic to the first SDN action based on the measured flow rate falling into the green classification.

At operation 514, upon determining the measured flow rate is above the first threshold, the networking device proceeds to determine whether the measured flow rate falls above or below the second threshold. If the measured flow rate is below the second threshold (but above the first threshold), the networking device proceeds to operation 516. If the measured flow rate is above the second threshold (and above the first threshold), the networking device proceeds to operation 518.

At operation 516, upon determining the measured flow rate is below the second threshold, the networking device routes the networking traffic to the second SDN action path. If the measured flow rate falls below the second threshold (and below the first threshold), the measured flow rate falls within the yellow classification.

At operation 518, upon determining the measured flow rate falls above the second threshold (and above the first threshold), the networking device routes the networking traffic to the third SDN action path. This indicates the measured flow rate is greater than the other classification and falls within the red classification. The third SDN action path may include a series of security SDN actions. It may slow processing to route each networking packet to the third SDN action path. Thus only those networking packets which may cause a security concern as indicated with the measured flow rate are routed to the series of security SDN actions.

FIG. 6 is a block diagram of a computing device 600 with a processing resource 602 to execute instructions 606-612 within a machine-readable storage medium 604. Specifically, the computing device 600 with the processing resource 602 identifies an SDN action path based on a measured flow rate. Although the computing device 600 includes a processing resource 602 and a machine-readable storage medium 604, it may also include other components that would be suitable to one skilled in the art. For example, the computing device 600 may include the networking component 102 as in FIG. 1. The computing device 600 is an electronic device with the processing resource 602 capable of executing instructions 606-612 and as such embodiments of the computing device 600 include a networking device, server, switch, mobile device, desktop computer, laptop, tablet, or other type of electronic device capable of executing instructions 606-612. The instructions 606-612 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processing resource 602 may fetch, decode, and execute instructions 606-612 to identify which SDN action path to route networking traffic in accordance with metered flow rate results. Specifically, the processing resource 602 executes instructions 606-612 to: filter networking traffic according to a specific criteria; identify a meter among the multiple meters in which to route the filtered networking traffic, each meter is specific to a different criteria; measure a flow rate of the filtered networking traffic; and identify which SDN action path among the multiple SDN action paths are specific to the meter.

The machine-readable storage medium 604 includes instructions 606-612 for the processing resource 602 to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 604 may include an application and/or firmware which can be utilized independently and/or in conjunction with the processing resource 602 to fetch, decode, and/or execute instructions of the machine-readable storage medium 604. The application and/or firmware may be stored on the machine-readable storage medium 604 and/or stored on another location of the computing device 600.

FIG. 7 is a block diagram of computing device 700 with a processing resource 702 to execute instructions 706-720 within a machine-readable storage medium 704. Specifically, the computing device 700 with the processing resource 702 is to identify an SDN action path specific to a meter by determining if a flow rate is above or below a first and second threshold. Although the computing device 700 includes processing resource 702 and machine-readable storage medium 704, it may also include other components that would be suitable to one skilled in the art. For example, the computing device 700 may include the networking component 102 as in FIG. 1. The computing device 700 is an electronic device with the processing resource 702 capable of executing instructions 706-720 and as such embodiments of the computing device 700 include a networking device, server, switch, mobile device, desktop computer, laptop, tablet, or other type of electronic device capable of executing instructions 706-720. The instructions 706-720 may be implemented as methods, functions, operations, and other processes implemented as machine-readable instructions stored on the storage medium 704, which may be non-transitory, such as hardware storage devices (e.g., random access memory (RAM), read only memory (ROM), erasable programmable ROM, electrically erasable ROM, hard drives, and flash memory).

The processing resource 702 may fetch, decode, and execute instructions 706-720 to identify the SDN action. Specifically, the processing resource 702 executes instructions 706-720 to: extract packet header information; filter the networking traffic according to a criteria; identify a meter in which to route the filtered networking traffic; measure a flow rate of the filtered networking traffic; use the measured flow rate to identify which SDN action to route the filtered networking traffic; identify a first SDN action path if the measured flow rate is below the first threshold and the second threshold; identify a second SDN action if the measured flow rate is above the first threshold and below the second threshold; and identify a third SDN action if the measured flow rate is above the first threshold and the second threshold.

The machine-readable storage medium 704 includes instructions 706-720 for the processing resource 702 to fetch, decode, and execute. In another embodiment, the machine-readable storage medium 704 may be an electronic, magnetic, optical, memory, storage, flash-drive, or other physical device that contains or stores executable instructions. Thus, the machine-readable storage medium 704 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 704 may include an application and/or firmware which can be utilized independently and/or in conjunction with the processing resource 702 to fetch, decode, and/or execute instructions of the machine-readable storage medium 704. The application and/or firmware may be stored on the machine-readable storage medium 704 and/or stored on another location of the computing device 700.

Although certain embodiments have been illustrated and described herein, it will be greatly appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a variety of ways. This application is intended to cover adaptions or variations of the embodiments discussed herein. Therefore, it is manifestly intended that embodiments be limited only by the claims and equivalents thereof.

We claim:

1. A method, executable by a networking component, the method comprising:
measuring a flow rate of network traffic; and
identifying a software defined networking (SDN) action path among multiple SDN action paths to perform on the network traffic based on the measured flow rate.

2. The method of claim 1 comprising:
receiving the multiple SDN action paths and corresponding flow rates from an SDN controller.

3. The method of claim 1 wherein identifying the SDN action among the multiple SDN action paths comprises:
identifying a first SDN action path if the measured flow rate is below a first threshold and a second threshold;
identifying a second SDN action path if the measured flow rate is above the first threshold and below the second threshold; and
identifying a third SDN action path if the measured flow rate is above the first threshold and the second threshold.

4. The method of claim 1 comprising:
extracting packet header information from the network traffic; and
identifying which meter among multiple meters corresponds to the extracted packet header information.

5. The method of claim 1 wherein the multiple SDN action paths are specific to a meter.

6. A system comprising:
a first meter, coupled to a networking component, to measure a first flow rate associated with network traffic;
a second meter, coupled to the networking component, to measure a second flow rate associated with the network traffic;
a first set of SDN action paths specific to the first meter;
a second set of SDN action paths specific to the second meter; and
the networking component to:
identify a first SDN action path among the first set of SDN action paths based on the measured first flow rate; and
identify a second SDN action path among the second set of SDN action paths based on the measured second flow rate.

7. The system of claim 6 further comprising:
a software defined networking (SDN) controller to configure the first set of SDN action paths specific to the first meter and the second set of SDN action paths specific to the second meter.

8. The system of claim 6 wherein to identify which SDN action path among the multiple SDN action paths to perform on the networking packet based on the measured data flow rate the networking component is to:
perform a first SDN action path if the measured flow rate is below a first threshold and a second threshold;
perform a second SDN action path if the measured flow rate is above the first threshold and below the second threshold; and
perform a third SDN action path if the measured flow rate is above the first threshold and the second threshold.

9. The system of claim 6 comprising wherein the networking component is to perform the identified first SDN action path and the identified second SDN action path on the network traffic.

10. The system of claim 6 comprising:
a classifier, coupled to the first meter and the second meter, to:
extract packet header information from the networking traffic; and
filter the networking traffic to the first meter and the second meter based on the extracted packet header information.

11. The system of claim 1 comprising:
a first table, coupled to the networking component, to list the first set of SDN action paths specific to the first meter; and
a second table, coupled to the networking component to list the second set of SDN actin paths specific to the second meter.

12. A non-transitory machine-readable storage medium comprising instructions that when executed by a processing resource cause a computing device to:
filter networking traffic according to a criteria;
identify a meter among multiple meters in which to route the filtered networking traffic, wherein each meter is specific to a different criteria;
measure a flow rate of the filtered networking traffic at the identified meter; and
identify a software defined networking (SDN) action path among multiple SDN action paths based on the measured flow rate.

13. The non-transitory machine-readable storage medium of claim 12 wherein to identify the SDN action among the multiple SDN action paths based on the measured flow rate comprises instructions that when executed by the processing resource cause the computing device to:
identify a first SDN action path if the measured flow rate is below a first threshold and a second threshold;
identify a second SDN action path if the measured flow rate is above the first threshold and below the second threshold; and
identify a third SDN action path if the measured flow rate is above the first threshold and the second threshold.

14. The non-transitory machine-readable storage medium of claim 12 wherein the multiple SDN actions are specific to each of the multiple meters.

15. The non-transitory machine-readable storage medium of claim 12 comprising instructions that when executed by the processing resource cause the computing device to:
extract packet header information from the networking traffic to obtain the filtered networking traffic.
